(19) United States
(12) Patent Application Publication
(10) Pub. No.: US 2006/0046706 A1
(43) Pub. Date: Mar. 2, 2006

(54) Monitoring and remote control of wireless communication device accessories and functionality

(76) Inventors: Jiansong Lin, Grayslake, IL (US); John C. Pincenti, Des Plaines, IL (US)

Correspondence Address: MOTOROLA INC, 600 NORTH US HIGHWAY 45, ROOM AS437, LIBERTYVILLE, IL, 60048-5343, US

(21) Appl. No.: 10/926,856

(22) Filed: Aug. 26, 2004

(51) Int. Cl. H04B 1/00

(52) U.S. Cl. 455/420

(57) ABSTRACT

A method in a wireless communication device, for example a cell phone, having at least one accessory with other than wireless communication functionality, including monitoring accessory usage (410), providing accessory usage information (420), receiving a message with control information (430), controlling the accessory based on the control information received. The situations may include, but not limited to, the wireless service providers

### FIELD OF THE DISCLOSURE

The present disclosure relates generally to wireless communication devices having non-communication functionality, and more particularly to monitoring and controlling accessories in wireless communication devices, for example, accessories and other functionality in cellular subscriber devices, from another wireless communication device, and methods.

### BACKGROUND OF THE DISCLOSURE

Wireless communication devices are commonly used or integrated with a variety of accessories and applications unrelated to the wireless communications capabilities. Cellular telephones and wireless enabled personal digital assistants (PDAs) now include, for example, data intensive applications like web browsers, AM/FM radio receivers, suites of interactive video games, and video playback capability, among other features. These accessories are presently disabled automatically upon receipt of an incoming call or message because there is limited processing power and memory capacity in existing portable wireless communication devices. Additional features, accessories and functionality will likely continue to be implemented in these and other portable electronic devices.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 illustrates an exemplary wireless communication system including a wireless communication network over which wireless communication devices communicate.

FIG. 2 illustrates an exemplary wireless communication device having one or more accessories.

FIG. 3 is an exemplary process flow diagram for controlling an accessory on a wireless communication device.

FIG. 4 is an exemplary process for monitoring, reporting and controlling accessory usage on a wireless communication device.

### DETAILED DESCRIPTION

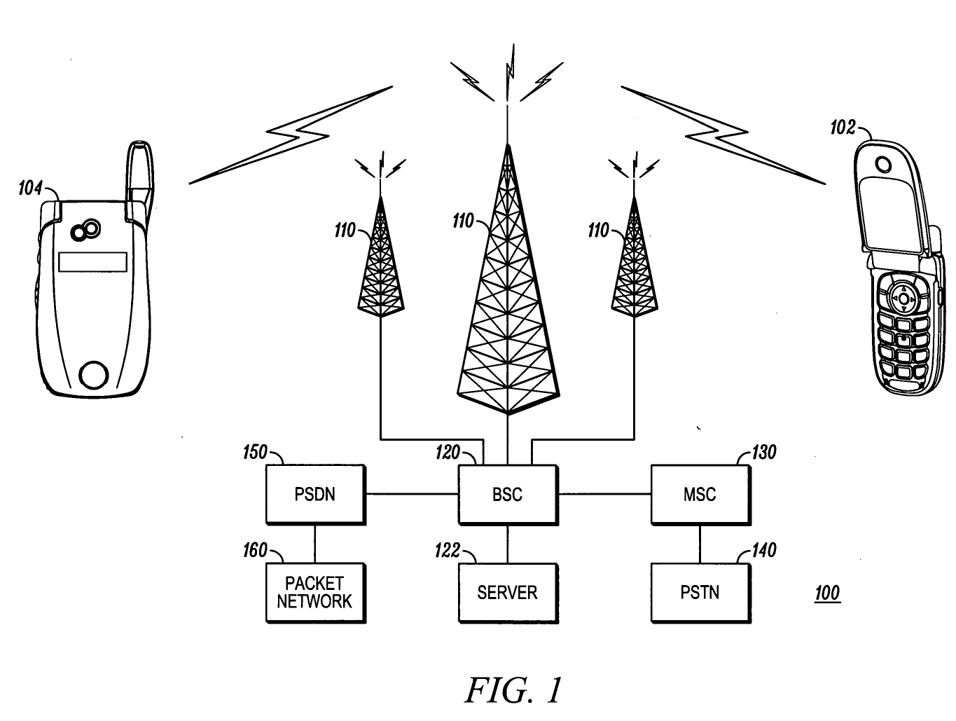

FIG. 1 illustrates an exemplary wireless communication system embodied as a cellular network 100 comprising generally one or more cellular base transceiver stations (BTS) 110 communicably coupled to a base station controller (BSC) 120. The exemplary base station controller 120 is communicably coupled to a mobile switching center (MSC) 130 that is communicably coupled to a public switched telephone network (PSTN) 140. The exemplary base station controller 130 is also communicably coupled to a packet data serving node (PDSN) 150, which is communicably coupled to a packet network 160.

The wireless communication network could be a 2^{nd or} 2.5 Generation Global System for Mobile communication (GSM) network or a 3^{rd} Generation (3G) Universal Mobile Telecommunications System (UMTS) cellular communication network, or some other wireless or cellular communication network. Alternatively, the wireless communication network may be embodied as a wireless local area network (WLAN), for example, an IEEE 802.xx protocol network, or some other protocol enabling wireless communications on licensed or unlicensed spectrum. Other network infrastructure architectures may not include the same entities illustrated in the exemplary embodiment of FIG. 1. The architectures of wireless communication networks are known generally by those having ordinary skill in the art.

In FIG. 1, the wireless communication network provides and supports wireless communications for one or more wireless communication stations. In the exemplary embodiment, the wireless communication devices are embodied as cellular telephone handsets 102 and 104. In other embodiments the wireless communication devices may be wireless local area network (WLAN) enabled devices, for example, multimode cellular/WLAN handsets devices. Although the wireless communication devices of the exemplary embodiments are portable or mobile devices, the instant disclosure also contemplates fixed-base or stationary wireless communication device embodiments communicably coupled to a wireless communications network, which may be a cellular network or some other network.

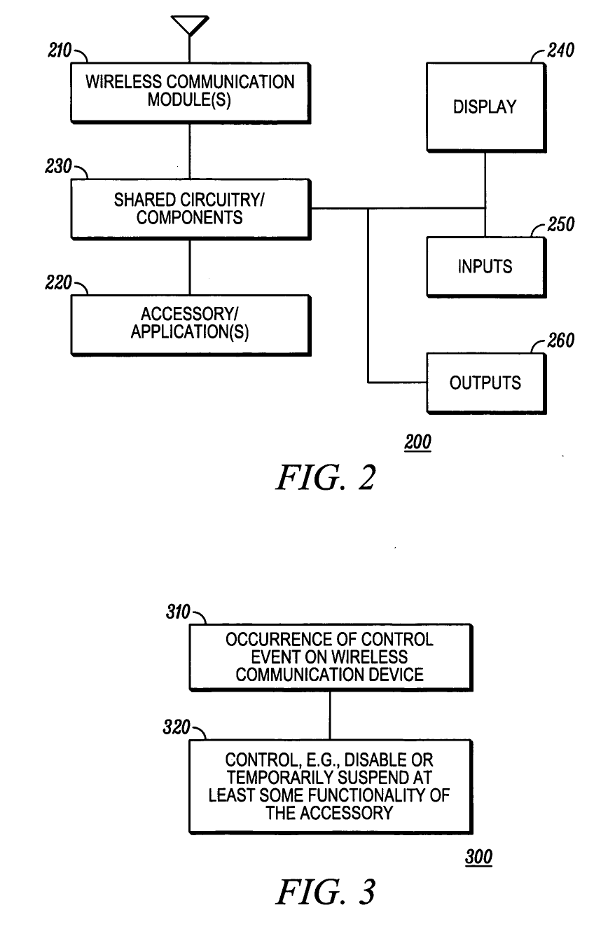

FIG. 2 illustrates an exemplary wireless communication device architecture schematic 200 comprising generally one or more wireless communication modules 210. The device also includes at least one accessory 220 with functionality other than that associated with communicating over the wireless communication network. The wireless communication module 210 and the accessory module 220 are coupled to shared circuitry and/or components 230, for example, a battery and related power control circuitry, a central controller/processor, memory, etc. In the exemplary embodiment, the wireless communication module 210 includes a cellular communication modem, though in other embodiments it may include a WiFi or other protocol wireless modem. The exemplary device architecture 200 also includes a visual display 240, and inputs 250 and outputs 260. Exemplary inputs include, among others, keypads, a touch-screen component of the visual display, a microphone, input ports, etc. Exemplary outputs include, among others, audio and output ports, etc. The accessory may be formed integrally with or coupled externally to the wireless communication device.

In one embodiment, the accessory is a television accessory, which may be implemented as a television signal receiver and a corresponding application with a user interface that enables users to view and control television functionality on the wireless communication device. In another embodiment, the accessory is an audio accessory, for example, a devices that plays of audio files, which may be formatted according to an open or proprietary audio file format, including but not limited to the MP3 audio file compression format, or the iPOD audio file format promulgated by the APPLE computer company, among others. The audio accessory may also include a corresponding application with a user interface enabling users to listen to and control audio functionality on the wireless communication device, though at least some of this functionality may be alternatively implemented in hardware. The audio accessory also may be embodied as an audio mixer or a wireless audio receiver, for example, an AM and/or FM and/or satellite, e.g., XM, receiver device. The audio receiver may also include a corresponding application with a user interface enabling users to listen to and control audio functionality on the wireless communication device, although at least some of this functionality may be implemented alternatively in hardware.

In other embodiments, the accessory may be embodied as a user interactive video game application, or as a video player application, for example, an MPEG or other video protocol. Such a device may play video from files stored on the device or it may play content streamed over a wire-line or wireless network. The accessory may also be some other video-based application, for example, a location technology based application including a route finder, a navigator, or and/or a location based commerce application, etc. The accessory may also be embodied as a short-range communication device, for example, a Bluetooth enabled device. The accessory may also be embodied as a still and/or video camera with a camera engine and corresponding application, etc. In still other embodiments, the accessory may be a productivity tool, for example, a calendar or email, a web browser or some other software application. More generally, the accessory may be any external and/or internally integrated hardware and/or software implementation used with the wireless communications device. Examples of externally coupled accessories include an automobile and other machines connected to the wireless communication network.

In one embodiment, the accessory and/or its associated functionality, other than the wireless communication functionality, is controlled by control information received from a remote device. In one embodiment, for example, the control information is embedded in an outgoing message, an outgoing call, or it is merely the payload of a signal.

In one embodiment, a controlling subscriber device sends the control information to a controlled subscriber device over the wireless communication network. This concept is not limited to wireless subscriber devices, as it may have applicability to wireless subscriber devices as well. The control information may be sent generally with any signal, including call set up messaging signals, among other signals and messages. In the network architecture of FIG. 1, for example, wireless communication device 102 sends a message including control information to device 104, which is controlled using the control information. In one embodiment, upon receipt of the control information, the wireless communication device 104 controls an accessory thereof using the control information, examples of which are discussed further below.

In one embodiment, the accessory or at least some of its functionality is disabled or suspended temporarily upon the occurrence of a specified event, for example, upon receipt of an incoming call or an incoming message having control information that controls the accessory. In one embodiment, the control information controls access to the operation of an accessory. For example, the user may be granted or denied access to a video-based accessory during specified time periods. In another embodiment, the control information controls the accessory upon the occurrence of a scheduled event, for example, an appointment reminder programmed in a calendar application. In the process 300 of FIG. 3, the occurrence of a control event, for example, the receipt of a signal having control information or a control command, is illustrated at logical block 310. At block 320, at least some functionality of the accessory is controlled upon the occurrence of the control event at block 310. In some embodiments, the occurrence of the control event may initiate a timer, the expiration of which initiates control of the accessory after a time period.

In the exemplary embodiment where the control event is an incoming call, for example, a voice call or a message, having control information, the control information may invoke temporary suspension or disablement of the accessory. In one embodiment, the accessory suspension or termination feature may be a user option that is selectable from a setup menu. The user setup option may also be selectable on an accessory basis, whereby the user may choose which accessories are susceptible to remote control using control information sent from a remote device. For example, a parent may program a child's handset to permit remote disabling of video-based features or other accessories. Thus a parent of guardian may disable, suspend or block access to certain accessories when attempting to place a voice call to a child or merely upon sending a control command to the wireless communication device. In another embodiment, the disablement or suspension may occur during certain events specified by someone other than the end-user, for example, cellular network operators may program cell phones to disable or suspend accessories upon receipt of control information during emergency, e.g., E-911, calls, or when pushing a software patch or a software update to the device or during other events where the users attention is required or desired, by sending a control command to the device.

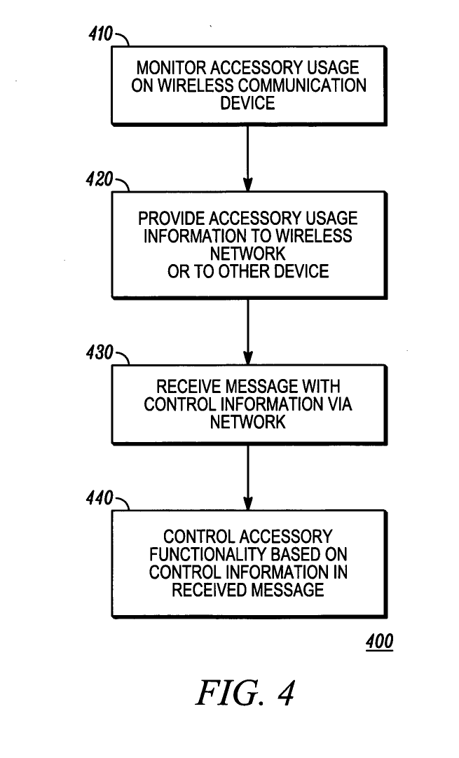

In some embodiments, the wireless communication device monitors the usage of one or more accessories coupled thereto. FIG. 4 illustrates a process on the wireless communication device wherein the device monitors or tracks the usage of one or more device accessories. In one exemplary embodiment, the usage information tracked is in terms of hours and/or minutes, which may be accumulated over time and stored as historical information. The accessory usage time may also be mapped relative to different time periods, for example, morning, afternoon and evening usage, or weekday and weekend usage, etc. The usage information may be stored on the device and updated periodically or on command, for example, upon receiving a command from the wireless communication network. In some embodiments, the subscriber or user has no control over the monitoring of the accessory, which is monitored by the network control under user consent.

In one embodiment, the accessory usage information is reported to a network infrastructure entity, for example, to a base station controller via a base transceiver station. In one embodiment, the information is forwarded to a database, for example, network server 122 illustrated in FIG. 1, where it is stored. In one embodiment, the wireless communication device reports the usage information periodically, for example, at scheduled intervals, or upon applying power to the device or upon the occurrence of some other event, with or without receiving an external prompt. In other embodiments, the reporting of the usage information is in response to a query, for example, from the network infrastructure in response to a request from a third party, for example, a parental subscriber device as discussed below. In some embodiments, a third party queries the network for accessory usage for another device. For example, in FIG. 1, the user of parental device 102 may query the network for accessory usage information for wireless communication device 104, used by a child. The network may in turn obtain the usage information requested directly from the wireless communication device or it may be obtained from the network, for example, from the server 122 in FIG. 1. Alternatively, the requesting wireless communication device 102 may query the other device 104 directly to obtain the accessory usage information.

FIG. 1 illustrates the act of providing accessory usage information from the wireless communication device to a network or to some other device via the network. In embodiments where the accessory usage information is provided to the network, for example, to the network for storage on server 122 in FIG. 1, the network may make the accessory usage information available to other devices upon request, as discussed above. In the exemplary television accessory embodiment, for example, a parent may inquire from device 102 about the video-based accessory usage by children operating device 104, and in response disable or otherwise control the accessory of the device.

In FIG. 4, at block 430, the wireless communication device having the accessory to be controlled receives a message with control information, for example, the accessory about which usage information was provided at block 420. In some embodiments, however, the message with control information may be sent to the wireless communication device, for example, to device 104 in FIG. 1, from the network or from another device, for example, from device 102 via the network, without prior performance of the activities of identified in blocks 410 and 420. At block 440, the wireless communication device controls the accessory as commanded by the control information received.

In one exemplary accessory control application, the control information received by the controlled device, for example, device 102 in FIG. 1, establishes time periods during which an accessory is accessible for enablement by the user. The control information may also establishes time periods during which the accessory is inaccessible to the user. For example, a parent may want to prevent their child's usage of television or video game accessories during school hours, and therefore prevent access to at least some video-based accessories on the wireless communications device used by the child.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a wireless communication device having an accessory, the method comprising:
receiving a payload carrying control information originating from a remote device;
controlling the accessory with control information after receiving the payload from the remote device.

2. The method of claim 1, controlling the accessory with the control information upon receipt.

3. The method of claim 1, receiving the payload carrying control information in one of a message and an incoming call.

4. The method of claim 1,
controlling the accessory includes one of enabling operation of the accessory during a time period and disabling operation of the accessory during another time period.

5. The method of claim 1,
controlling the accessory includes controlling access to usage of the accessory by a user of the wireless communication device.

6. The method of claim 1,
the accessory is a video-based accessory,
controlling the video-based accessory with the control information in response to receiving the payload from the remote device.

7. The method of claim 6,
controlling the video-based accessory includes one of enabling and disabling operation of the video-based accessory.

8. A method in a wireless subscriber device having an accessory, the method comprising:
receiving a signal associated with an incoming call from a wireless service provider,
the signal including control information;
automatically controlling the accessory with the control information received.

9. The method of claim 8, receiving the control information at the wireless subscriber device with one of a message or voice call.

10. The method of claim 8,
controlling the accessory includes controlling access to operation of the accessory.

11. The method of claim 8,
controlling the accessory includes temporarily suspending operation of the accessory during a call.

12. A method in a wireless communication device having an accessory, the method comprising:
sending usage information about the accessory to a wireless communication network infrastructure entity;
receiving control information based on the usage information sent;
controlling the accessory with the control information received.

13. The method of claim 12, controlling the accessory with the control information received by controlling access to operation of the accessory.

14. The method of claim 12, providing information about the usage of the accessory includes providing usage information for a video-based accessory to the wireless communication network infrastructure entity.

15. The method of claim 12, monitoring usage of the accessory before sending the usage information about the accessory to the wireless communication network infrastructure entity.

16. A method in an infrastructure entity of a wireless communication network, the method comprising:
receiving accessory usage information from a wireless subscriber device communicably coupled to the wireless communication network;
sending the accessory usage information to another wireless subscriber device communicably to the wireless communication network.

17. The method of claim 16, sending the accessory usage information to the other wireless subscriber device in response to a request from the other wireless subscriber device.

18. The method of claim 16,
receiving control information at the infrastructure entity from the wireless subscriber device to which the accessory usage information was sent,
sending the control information to the wireless subscriber device from which the accessory usage information was received.

19. A method in a wireless subscriber device that communicates in a wireless communication network, the method comprising:
obtaining accessory usage information for another wireless subscriber device in the wireless communication network;
sending a control signal to the other wireless communication device via the wireless communication network,
the control information controlling an accessory of the other wireless subscriber device based on the accessory usage information obtained.

20. The method of claim 19,
sending the control information as one of a signal payload, embedded in an outgoing message, and embedded in an outgoing call, addressed to the other wireless subscriber device.
